(19) United States
(12) Patent Application Publication
(10) Pub. No.: US 2002/0039111 A1
(43) Pub. Date: Apr. 4, 2002

(54) Automated visual tracking for computer access

(76) Inventors: James Gips, Medfield, MA (US); Margrit Betke, Cambridge, MA (US)

Correspondence Address: Patent Group, Foley, Hoag & Eliot LLP, One Post Office Square, Boston, MA, 02109-2170, US

(21) Appl. No.: 09/892,254

(22) Filed: Jun. 27, 2001

Related U.S. Application Data
(60) Provisional application No. 60/214,471, filed on Jun. 27, 2000.

(51) Int. Cl. G06F 3/00

(52) U.S. Cl. 345/700

(57) ABSTRACT

The invention comprises a system and method for permitting a computer user or the user of a system comprising a video display to control an indicator, such as a mouse pointer or cursor, on a computer monitor or video display screen. The system and method uses a video camera pointed at the user to capture the user's image. The location in the video camera field of view of a chosen feature of the user's image is used to control the location of the indicator on the monitor or display screen. Thus, by control of the motion of the chosen feature, which for example may be the user's nose, the user may control or provide input into a computer program, video game or other device or system.

### RELATED APPLICATIONS

This application claims priority to, and incorporates by reference, the entire disclosure of U.S. Provisional Patent Application No. 60/214,471, filed on Jun. 27, 2000.

### BACKGROUND

1. Field of the Invention

This invention generally relates to computer and other systems with video displays, and more specifically to techniques for permitting a user to indicate a location of interest to him on a computer monitor or other video display.

2. Description of Related Art and the Problem

It is well known in the art to use devices such as that known as a “mouse” to indicate a location of interest to a user on a computer screen, and thereby to control a program or programs of instructions executed by a computer or a computer system. Use of a mouse or other control device can also facilitate entry of data into a computer or computer system, and navigation by a user on the Internet and/or World Wide Web (“Web”) or other computer network. Other uses of a mouse or another control device in conjunction with a computer will also be apparent to one of ordinary skill in the art, and such devices are also frequently employed in connection with other systems that use video displays, such as video game consoles.

One problem in permitting individuals with certain physical limitations to exploit computers, computer systems, and other systems that use video displays, and networks such as the Internet or Web to the maximum may be that, insofar as a physical limitation limits or precludes an individual from easily manipulating a mouse or other control device, that individual's ability to control a computer or computer system, navigate the Web, or play a computer game may be correspondingly limited.

One approach to overcoming this problem is the use of voice controls. However, although some voice controls have improved markedly in recent years, other voice controls still may be limited in flexibility and may be awkward or slow to use. In addition, insofar as an individual also is limited in his or her ability to speak, a voice-controlled system, no matter how flexible and convenient, may not be a useful solution.

Other computer access methods have been developed, for example, to help people who are quadriplegic and nonverbal: external switches, devices to detect small muscle movements or eye blinks, head indicators, infrared or near infrared reflective systems, infrared or near infrared camera-based systems to detect eye movements, electrode-based systems to measure the angle of an eye in the head, even systems to detect features in an EEG. Such devices have helped many people access computers. Still, these devices may not be fully satisfactory in allowing people with physical limitations to conveniently and reliably access computers and networks.

For example, in communication systems which use movements as a means to answer questions or respond to others, such as permitting one wink to mean “yes” and two winks “no”, a problem may be that the systems do not allow initiation or direct selection by a user. Another person may be required to initiate a question to the person with the disability.

As another example, various commercial devices or systems are based on measuring corneal reflections. L. Young and D. Sheena, Survey of Eye Movement Recording Methods, Behavior Research Methods & Instrumentation, 7(5):397-429, 1975; T. Hutchinson, K. P. White Jr., W. N. Martin, K. C. Reichert, and L. A. Frey, Human Computer Interaction Using Eye-gaze Input, IEEE Transactions on Systems, Man and Cybernetics, 19(6): 1527-1553, 1989; Permobil Meditech AB, Eye-Trace System, Timra, Sweden, http: //www.algonet.se/˜eyetrace; Applied Science Laboratories, Bedford, Mass., http://www.a-s-l.com. Such methods image a light pattern that occurs when incident infrared or near infrared light is reflected from a convex surface of a cornea. Images produced by photocells may then be analyzed for eye movement and gaze direction, or infrared LEDs and cameras may be used. See -http://www.almaden.ibm.com/cs/blueeyes/find.html. Other control devices measure an electro-oculographic potential (EOG) to detect eye movements. L. Young and D. Sheena, Survey of Eye Movement Recording Methods, Behavior Research Methods & Instrumentation, 7(5):397-429, 1975, or analyze features in electroencephalograms (EEGs). Z. A. Keirn and J. I. Aunon, Man-machine Communications Through Brain-wave Processing, IEEE Eng. Med. Biol., pages 55-57, May 1990; M. Pregenzer and G. Pfurtscheller, Frequency Component Selection for an EEG-based Brain to Computer Interface, IEEE Transactions on Rehabilitation Engineering, 7(4): 413-419, 1999.

“EagleEyes,” an EOG-based system that enables people who can move their eyes to control a mouse, has been designed. P. DiMattia, F. X. Curran, and J. Gips, An Eye Control Teaching Device for Students without Language Expressive Capacity: EagleEyes, Edwin Mellen Press (2001), see also http://www.bc.edu/eagleeyes; J. Gips, On Building Intelligence Into EagleEyes, in V. Mittal, H. A. Yanco, J. Aronis, and R. Simpson, editors, Lecture Notes in AI: Assistive Technology and Artificial Intelligence, Springer Verlag, 1998; J. Gips, P. DiMattia, and F.X. Curran, Progress with EagleEyes, in Proceedings of the International Society for Augmentative and Alternative Communication Conference, pages 458-459, Dublin, Ireland, 1998; J. Tecce, J. Gips, P. Olivieri, L. Pok, and M. Consiglio, Eye Movement Control of Computer Functions, International Journal of Psychophysiology, 29(3), 1998; J. Gips, P. DiMattia, F. X. Curran, and P. Olivieri, Using EagleEyes—An Electrodes Based Device for Controlling the Computer with Your Eyes—To Help People with Special Needs, in J. Klaus, E. Auff, W. Kremser, and W. Zagler, editors, Interdisciplinary Aspects on Computers Helping People with Special Needs, R. Oldenbourg, Vienna, 1996; J. Gips, P. Olivieri, and J. J. Tecce, Direct Control of the Computer Through Electrodes Placed Around the Eyes, in M. J. Smith and G. Salvendy, editors, Human-Computer Interaction: Applications and Case Studies, pages 630-635, Elsevier, 1993. Five electrodes are attached on a user's face to measure changes in EOG that occur when the position of an eye relative to the head changes. A driver program translates amplified voltages into a position of a cursor on a screen.

A system for people with quadriplegia who retained an ability to rotate their heads has recently been developed. Y. L. Chen, F. T. Tang, W. H. Chang, M. K. Wong, Y. Y. Shih, and T. S. Kuo, The New Design of an Infrared-controlled Human Computer Interface for the Disabled, IEEE Transactions on Rehabilitation Engineering, 7(4):474-481, December 1999. It contains an infrared transmitter, mounted onto a user's eyeglasses, a set of infrared receiving modules that substitute for keys of a computer keyboard, and a tongue-touch panel to activate an infrared beam.

EOG and corneal reflection systems may allow reliable gaze tracking and have helped people with severe disabilities access a computer. For example, EagleEyes has made improvements in children's lives. Still, there may be many people without a reliable, affordable, and comfortable means to access a computer. For example, the Permobil Eye Tracker, which uses goggles containing infrared light emitters and diodes for eye-movement detection, may cost between $9,900 and $22,460. EOG is also not inexpensive, since new electrode pads, which cost about $3, may be used for each computer session. Head-mounted devices, electrodes, goggles, and mouthsticks may be uncomfortable to wear or use. Commercial head mounted devices may not be able to be adjusted to fit a child's head. Electrodes may fall off when a user perspires. Further, some users may dislike to be touched on their face.

Other prior solutions may also suffer from limitations that may prevent them from completely solving this problem. Essa IA, Computers Seeing People, AI Magazine, Summer 1999, pp. 69-82; Betke M and Kawai J, Gaze Detection via Self-Organizing Gray-Scale Units, Proceedings of The International Workshop on Recognition, Analysis, and Tracking of Faces and Gestures, IEEE Press, 1999, 70-76. See http://cs-pub.bu.edu/fac/betke.

Accordingly, a control system that works under normal lighting conditions to permit a person to replicate functions of a computer mouse or other control device that works in conjunction with a video display, without a need to utilize his or her hands and arms, or voice, might be of significant use, for example, to people who are quadriplegic and nonverbal.

### SUMMARY OF THE INVENTION

In accordance with one embodiment of the invention, a method for providing input to a computer program has been developed, comprising: choosing a portion of a computer user's body or face, or some other feature associated with the computer user; monitoring the location of said portion with a video camera; and providing input to the computer program at a given time based upon the location of the chosen portion in the video image from the camera at the given time.

In accordance with another embodiment, a system has been developed for providing input to a computer by a user, comprising: a video camera for capturing video images of a feature associated with the user; a tracker for receiving the video images and outputting data signals corresponding to locations of the feature; and a driver for receiving the data signals and controlling an input device of the computer in response to the data signals. The tracker may comprise a video acquisition board, which may digitize the video images from the video camera, a memory to store the digitized images and one or more processors to compare the digitized images so as to determine the location, or movement of the feature and output the data signals. The one or more processors may comprise computer-readable medium that may have instructions for controlling a computer system. The instructions may control the computer system so as to choose stored image data of a trial area in a video image most similar to stored image data for a fixed area containing the feature as a known point, where the fixed area is within a prior video image. The instructions may further control the computer system to determine the location of the feature as a point within the trial area bearing the same relationship to the trial area as the known point does to the fixed area.

The input provided to the computer program at the given time may comprise vertical and horizontal coordinates, and the vertical and horizontal coordinates input may be used as a basis for locating a cursor on a computer monitor screen being used by the computer program to display material for the user.

The cursor location may be determined at the given time (1) based upon the chosen portion's location in the video image at the given time, (2) based upon a location of the cursor at a previous time and a change in the chosen portion's location in the video image between the previous time and the given time, or (3) based upon a location of the cursor at a previous time and the chosen portion's location in the video image at the given time.

The input may be provided in response to the chosen portion's location in the video image changing by less than a defined amount during a defined period of time.

The input provided may be selected from a group consisting of letters, numbers, spaces, punctuation marks, other defined characters and signals associated with defined actions to be taken by the computer program, and the selection of the input may be determined by the location of the chosen portion of the user's body or face.

The input provided may be based upon the change in the chosen portion's location in the video image between a previous time and the given time.

The chosen portion's location in the video image may be determined by a computer other than the computer on which the program to which the input is provided is running, or by the same computer as the computer on which the program to which the input is provided is running.

The chosen portion's location in the video image at the given time may be determined by comparing video input signals for specified trial areas of the image at the given time with video input signals for an area of the image previously determined to contain the video image of the chosen portion at a prior time, and selecting as the chosen portion's location in the video image at the given time the center of the specified trial area most similar to the previously determined area. The determination of which trial area is most similar to the previously determined area may be made by calculation of normalized correlation coefficients between the video signals in the previously determined area and in each trial area. The video signals used may be greyscale intensity signals.

The computer program may be a Web browser.

Other applications and methods of use of the system are also comprised within the invention and are disclosed herein.

### BRIEF DESCRIPTION OF THE DRAWINGS

The above-mentioned and other features of the invention will now become apparent by reference to the following description taken in connection with the accompanying drawings, in which:

FIG. 1 illustrates an embodiment of the system utilizing two computers;

FIG. 2 illustrates the tracking of the selected subimage in the camera vision field;

FIG. 3 illustrates a spelling board which may be used with the system.

### DETAILED DESCRIPTION OF THE PREFERRED EMBODIMENT(S)

The invention, in one embodiment, comprises use of a video camera in a system to permit a user to control the location of a pointer or other indicator (e.g., a mouse pointer or cursor) on a computer monitor screen or other video display. The indicator location may be utilized as a means of providing input to a computer, a video game, or a network, for control, to input data or information, or for other purposes, in a manner analogous to the manner in which an indicator location on a computer monitor is controlled by a mouse, or in which another tracking device such as a touchpad or joystick is utilized.

According to one embodiment of the invention, a camera may be appropriately mounted or otherwise located, such that it views a user who may be situated appropriately, such that he or she in turn may view a monitor screen or other video display.

According to an embodiment of the invention, initially a subimage of the image as seen by the camera may be selected either by a person or automatically. The future location of the selected subimage in the camera image may then be used to control the indicator coordinates on the screen.

In each successive image frame, or at preselected intervals of time, a fresh subimage may be selected based on its similarity (as measured by a correlation function or other chosen measure) to the previously selected subimage. According to the invention, the location of the new selected subimage may then be used to compute a new position of the indicator on the screen.

The process may be continued indefinitely, to permit the user to move the indicator on the computer monitor or other video display screen.

For example, an image of the user's chin or finger may be selected as the subimage of interest, and tracked using the video camera. As the user moves the chin or finger, the screen indicator may be moved accordingly.

Alternatively, according to the invention, two or more subimages may be utilized, rather than a single subimage. For example, subimages of the user's two mouth corners may be tracked. If this is done, the indicator location may be computed by appropriately averaging the locations as determined by each subimage. In doing this, the various subimages may be given equal weight, or the weights accorded to each subimage may be varied in accordance with algorithms for minimizing error that will be well known to one of ordinary skill in the art. In the case where the two corners of the mouth are used as the selected subimages, for example, if equal weighting is utilized the location utilized to determine indicator movement in effect corresponds to the point mid-way between the mouth comers.

An embodiment of the invention of course may be utilized by people without disabilities as well as by people with disabilities. Control of an indicator on a computer monitor screen by means of visual tracking of motions of a head or another body part may be useful as a means of input into computer games as well as for transmitting information to computer programs.

The system may also be useful, however, for people who are disabled, for example but not limited to people who are quadriplegic and nonverbal, as from cerebral palsy or traumatic brain injury or stroke, and who have limited motions they can make voluntarily. Some people can move their heads. Some can blink or wink voluntarily. Some can move their eyes or tongue. According to the system of the invention, the subimage or subimages utilized to control the indicator location may be selected based upon the bodily-control abilities of a specific individual user.

In addition to using the location of the indicator on the computer monitor or other video display screen as a signal, the invention permits the use of the relative motion of the indicator as a signal. As one example, a user could signal a choice to accept or decline an option presented to him or her through a computer monitor as from a computer program or a Web site by nodding his or her head affirmatively, or shaking it from side to side negatively.

According to the system of one embodiment of the invention, a particular user may experiment with using alternative subimages as the selected subimages, and select one for permanent use based upon speed, degree of effort required, and observed error rates of the alternatives tried.

Two embodiments of the system of the invention will now be described. It should be understood, however, that this description is not intended to limit the invention as disclosed herein in any way.

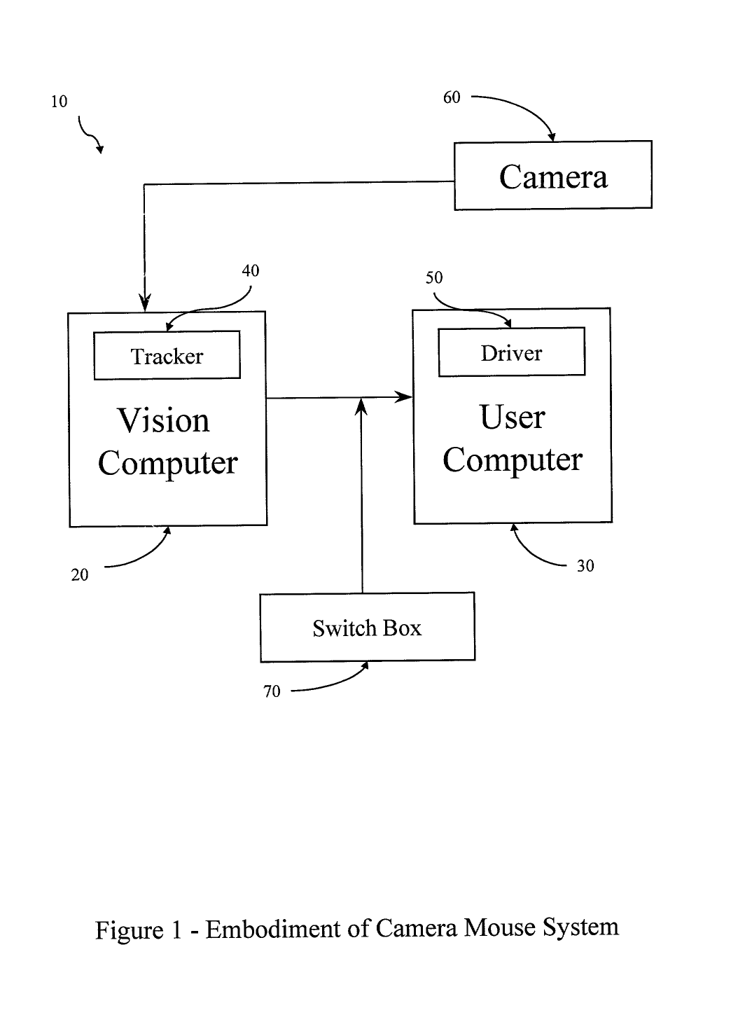

One embodiment of the system 10 is illustrated in FIG. 1. It involves two computers: the vision computer 20, which does the visual tracking with a tracker (visual tracking program) 40, and the user computer 30, which runs a special driver 50 and any application software the user wishes to use. It should be understood, however, that implementations of the invention involving the use of only a single computer also are within the scope of the invention and may predominate, as computer processing power increases. In particular, an embodiment in which only a single computer is utilized may be employed. The single computer, by way of example, may be a 1 GHz Pentium III system with double processors, 256 MB RAM and a Windows 2000 operating system. Alternatively, it may be a 1.5 GHz Pentium IV system, with a Windows 2000 operating system. It will be understood by one of ordinary skill in the art that other computer systems of equivalent or greater processing capacity may be used and that other conventional computer system characteristics beyond those stated herein should be chosen to appropriately optimize the system operation.

In the two-computer embodiment, the vision computer 20 may be a 550 MHz Pentium II machine with a Windows NT operating system, a Matrox Meteor-II video capture board, and a National Instruments Data Acquisition Board.

In the one-computer embodiment, the video capture board may be in the computer.

The video capture board may digitize an analog NTSC signal received from a Sony EVI-D30 camera 60 mounted above or below the monitor of the user computer 30 and may supply images at a 30 frames per second rate. Other computers, video capture boards, data acquisition boards and video cameras may be used, however, and the number of frames received per second may be varied without departing from the spirit and scope of the invention.

The image used in these embodiments is of size 320 by 240 pixels, but this may be varied depending upon operational factors that will be understood by one of ordinary skill in the art.

The image sequence from the camera 60 may be displayed in a window on a monitor of the vision computer 20 by the tracker (visual tracking program) 40. In the case of a one-computer system, the image sequence may be displayed in a window on a monitor of that computer.

Initially, in these embodiments an operator may use the camera 60 remote control to adjust the pan-tilt-zoom of the camera 60 so that a prospective user's face is centered in the camera image. The operator may then use a vision computer 20 mouse to click on a feature in the image to be tracked, perhaps the tip of the user's nose. The vision computer 20 may then select a template by drawing a 15 by 15 pixel square centered on the point clicked and outputs the coordinates of the center of the square. These will be used by the user computer 30 to determine the mouse coordinates. The size of the template in pixels may be varied depending upon operational factors that will be understood by one of ordinary skill in the art.

It will be understood that in the one-computer embodiment the computer's mouse may be used rather than a separate vision computer mouse to select the feature to be tracked and the computer may further select the template as well.

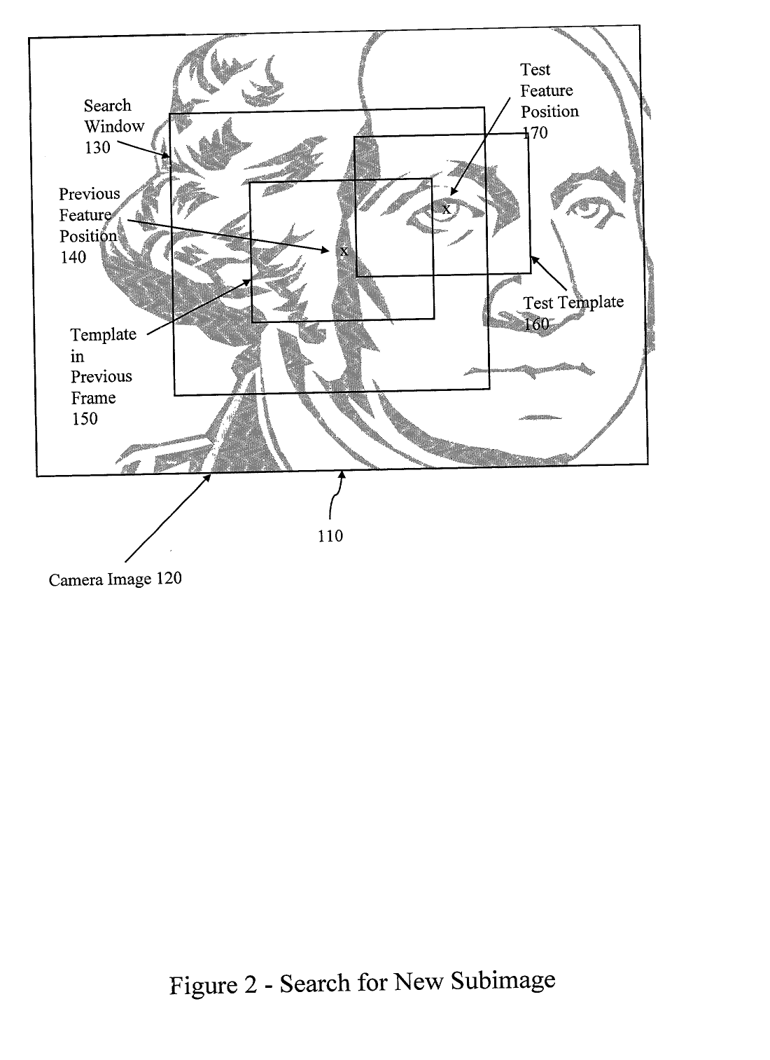

FIG. 2 illustrates (but not to scale) the process that may be followed in these embodiments to determine and select the subimage corresponding to the selected feature in a subsequent iteration. In the following description, the phrase “vision computer” will be understood also to refer to the single computer in the one-computer embodiment.

As noted above, in these embodiments, 30 times per second the vision computer may receive a new image 120 from the camera, which new image 120 may fall within the camera image field of view 110. In FIG. 2, the selected feature (here, the user's eye) was located at previous feature position 140 in the image field 110 in the prior iteration, and template 150 represents the template centered upon and therefore associated with previous feature position 140. In these embodiments, the vision computer may then determine which 15 by 15 square new subimage is most similar (as measured by a correlation function in these embodiments, although other measures may be used) to the previously-selected subimage. In these embodiments, the vision computer program may determine the most similar square by examining a search window 130 comprising 1600 pixels around the previous feature position 140; for each pixel inside the search window 130, a 15 by 15 trial square or template may be selected (which may itself extend outside the search window 130), centered upon that pixel and containing a test subimage. Each trial square or template may then be compared to template 150 from the previous frame; the pixel whose test template is most closely correlated with the previous template 150 may then be chosen as the location of the selected subimage in this new iteration. FIG. 2 illustrates the comparison of one particular 15 by 15 trial square subimage or test template 160 with the prior template 150. In FIG. 2, the test template 160 illustrated is in fact the template centered upon the new iteration feature position 170. Hence template 160 will be the subimage selected for use in this iteration when the system has completed its examination of all of the test templates associated with the search window 130.

In these embodiments, the tracking performance of the system may be a function of template and search window sizes, speed of the vision computer's processor, and the velocity of the feature's motion. It may also depend on the choice of the feature being tracked.

The size of the search window 130 examined may be varied depending upon operational factors that will be understood by one of ordinary skill in the art. Large template or search window sizes may require computational resources that may reduce the frame rate substantially in these embodiments. In the event that the processing time increases, the system may not have completed analyzing data from one camera image and selecting a new subimage before the next image is received. In that event, the system may either abandon processing the current data without choosing a new subimage, and go on to the new data, or it may complete the processing of the current data and therefore delay or forego entirely the processing of the new data. In either circumstance, incoming frames may therefore be skipped. If the processing time increases such that many incoming frames are skipped, which means that the rate of the frames that are used for tracking drops well below 30 Hz in these embodiments, a constant brightness assumption may not hold for the tracked feature, even if it is still located within the search window. For the worse, when frames are skipped, the feature may move outside the search window.

In particular, the size of the search area may be increased depending on the amount of processing power available. The system may offer the user the choice of the search area to be searched. Alternatively, the system may adjust the search size automatically by increasing it until the frame rate drops below 26 frames per second, and decreasing it as necessary to maintain a frame rate at or above 26 frames per second.

A large search window may be useful for finding a feature that moves quickly. Further, a large template size may be beneficial, because it provides a large sample size for determining sample mean and variance values in the computation of the normalized correlation coefficient (as discussed below) or other measure of similarity which may be used. Small templates may be more likely to match with arbitrary background areas because they may not have enough brightness variations, e.g., texture or lines, to be recognized as distinct features. This phenomenon has been studied. The size of the template is not the only issue, but more importantly, tracking performance may depend on the “complexity” of the template. M. Betke and N. C. Makris, Information Conserving Object Recognition, in Proceedings of the Sixth International Conference on Computer Vision, pages 145-152, Mumbai, India, January 1998, IEEE Computer Society.

In these embodiments, the system may use greyscale (intensity) information for a pixel, and not any color information, although it would be within the scope of the invention to extend the process to take into account the color information associated with each pixel. It can be assumed that a template around a feature in a new frame, as template 160, has a brightness pattern that is very similar to the template around the same feature in the previous frame, i.e., template 150. This “constant brightness assumption” is often made when designing algorithms for motion analysis in images. B. K. P. Horn, Robot Vision, MIT Press, 1986; M. Betke, E. Haritaoglu, and L. Davis, Real-time Multiple Vehicle Detection and Tracking from a Moving Vehicle, Machine Vision and Applications, vol. 12-2, Aug. 30, 2000.

In these embodiments, the system may calculate the normalized correlation coefficient r(s,t) for the selected subimage s from the previous frame with each trial subimage t in the current frame

$$r ( s , t ) = \frac{A \sum s ( x , y ) t ( x , y ) - \sum s ( x , y ) \sum t ( x , y )}{{σ}_{s} {σ}_{t}}$$

where:

A is the number of pixels in the subimage, namely 225 in these embodiments,

s(x, y) is the greyscale intensity for the pixel at the location x, y within the selected subimage in the previous frame,

t (x, y) is the greyscale intensity for the pixel at the location x, y within the trial subimage in the current frame, and

σₛ={square root over (AΣs(x,y)²−(Σs(x,y))²)} and σₜ={square root over (AΣt(x,y)²−(Σt(x,y))²)}.

In these embodiments, the trial subimage t with the highest normalized correlation coefficient r(s, t) in the current frame may be selected. The coordinates of the center of this subimage may then be sent to the user computer. (Of course, in the one-computer embodiment this step of sending the coordinates to a separate computer may not take place.) The particular formulaic quantity maximized may be varied without departing from the spirit and scope of the invention.

In these embodiments, a match between a template (the subimage chosen in the prior iteration) and the best matching template or subimage in the current iteration within the search window may be called sufficient if the normalized correlation coefficient is at least 0.8, and correlation coefficients for the best-matching subimage in the current iteration within the search window below 0.8 may be considered to describe insufficient matches. Insufficient matches may occur, for example, when the feature cannot be found in the search window because the user moved quickly or moved out of the camera's field of view. This results in an undesired match with a feature. For example, if the right eye is being tracked and the user turns his or her head quickly to the right, so that only the profile is seen, the right eye becomes occluded. A nearby feature, for example, the top of the nose, may then be cropped and tracked instead of the eye.

When an insufficient match occurs, in these embodiments, the subimage with the highest correlation coefficient may be chosen in any event, but alternatively according to one embodiment of the invention the user or an operator of the system may reset the system to the desired feature, or the system may be required to do a more extensive search beyond the originally-chosen search window.

Other cut-off thresholds may be used without departing from the spirit or scope of the invention. The threshold of 0.8 was chosen in these embodiments after extensive experiments that resulted in an average correlation for a successful match of 0.986, while the correlation for poor matches under normal lighting varied between 0.7 and 0.8. In these embodiments, if the correlation coefficient is above 0.8, but considerably less than 1, the initially selected feature may not be in the center of the template anymore and attention may have “drifted” to another nearby feature. In this case, however, tracking performance is usually sufficient for the applications tested in these embodiments.

The number of insufficient matches in the two-computer embodiment may be zero until the search window becomes so large (44 pixels wide) that the frame rate drops to about 20 Hz. The correlation coefficient of the best match then may drop and several insufficient matches may be found.

In order to find good parameter values for search window and template sizes that balance the tradeoff between number of frames examined per second and the sizes of the areas searched and matched, the time it takes to search for the best correlation coefficient was measured as a function of window and template widths in the two-computer embodiment. An increase in the size of the template caused the frame rate to drop. Based on these observations, a template size of 15×15 pixels may be chosen in these embodiments. This allows for a large enough template to capture a feature, while at the same time allowing enough time between frames to have a 40×40 pixel search window. Other embodiments of the system may lead to other choices of template size and search window based on the above considerations and others which will be apparent to one of ordinary skill in the art.

In these embodiments, the location of the center of the chosen subimage may be used to locate the indicator on the computer monitor screen. While different formulae may be used to translate the chosen subimage location into a location of the indicator on the monitor screen, in these embodiments where the camera image may be 320 pixels wide and 240 pixels in height, the following is used:

| | Horizontal Coordinate of Indicator on |
|---|---|
| Horizontal Coordinate of Subimage | Screen |
| 0-79 | Left edge of screen |
| 80-239 | Linearly placed on screen |
| 240-319 | Right edge of screen |

The vertical location is similarly translated in these embodiments, according to the following:

| | Vertical Coordinate of Indicator on |
|---|---|
| Vertical Coordinate of Subimage | Screen |
| 0-59 | Top edge of screen |
| 60-179 | Linearly placed on screen |
| 180-239 | Bottom edge of screen |

The number of pixels at each edge of the subimage that are translated into an indicator location at the edge of the screen may be varied, according to various considerations that will be apparent to one of ordinary skill in the art. For example, increasing the number of pixels that are made equivalent to a location at the monitor screen edge has the effect of magnifying the amount of motion across the monitor screen that results from a small movement by the user.

The process of choosing the correct subimage and locating the indicator on the monitor screen may be repeated for each frame.

If the program completely loses the desired feature, in these embodiments the operator may intervene and click on the feature in the image and that will become the center of the new selected subimage.

In the two-computer embodiments, the vision computer 20 may utilize the above process to determine the x, y coordinates of the tracked feature, and may then pass those coordinates to the National Instruments Data Acquisition Board which in turn may transform the coordinates into voltages that may be sent to the user computer 30. In the one-computer embodiment, this process may occur internally in that computer.

In the two-computer embodiments, the user computer 30 may be a 550 MHz Pentium II machine using the Windows 98 operating system and running a special driver program 50 in the background. It may be equipped with a National Instruments Data Acquisition Board which converts the voltages received from the vision computer 20 into screen coordinates and sends them to the driver program 50. The driver program 50 may take the coordinates, fit them to the current screen resolution, and may then substitute them for the cursor or mouse coordinates in the system. The driver program 50 may be based on software developed for EagleEyes, an electrodes-based system that allows for control of the mouse by changing the angle of the eyes in the head. DiMattia P, Curran F X, and Gips J, An Eye Control Teaching Device for Students without Language Expressive Capacity: EagleEyes, Edwin Mellen Press (2001). See also http://www.bc.edu/eagleeyes. Other computers may be utilized for the user computer 30 without departing from the spirit and scope of the invention, and other driver programs 50 may be used to determine and substitute the new indicator coordinates on the screen for the cursor or mouse coordinates.

Commercial or custom software may be run on the user computer 30 in conjunction with the invention. The visual tracker as implemented by the invention may act as the mouse for the software. In this implementation, a manual switch box 70 may be used to switch from the regular mouse to the visual tracker of the invention and back, although other methods of transferring control may equally well be used. For example, a keyboard key such as the NumLock or CapsLock key may be used. The user may move the mouse indicator on the monitor screen by moving his head (nose) or finger in space, depending on the body part chosen.

In the two-computer implementation, the driver program 50 may contain adjustments for horizontal and vertical “gain.” High gain causes small movements of the head to move the indicator greater distances, though with less accuracy. Adjusting the gain is similar to adjusting the zoom on the camera, but not identical. The gain may be adjusted as desired to meet the user's needs and degree of coordination. This may be adjusted for a user by trial and error techniques. Changing the zoom of the camera 60 causes the vision algorithm to track the desired feature with either less or more detail. If the camera is zoomed-in on a feature, the feature will encompass a greater proportion of the screen and thus small movements by the user will display larger movements of the indicator. Conversely, if the camera 60 is zoomed-out, the feature will encompass a smaller portion of the screen, and thus larger movements will be required to move the indicator.

Many programs require mouse clicks to select items on the screen. The driver program may be set to generate mouse clicks based on “dwell time.” In this implementation, with this feature, if the user keeps the indicator within, typically, a 30 pixel radius for, typically, 0.7 second a mouse click may be generated by the driver and received by the application program. The dwell time and radius may be varied according to user needs, comfort and abilities.

Occasionally in this implementation the, selected subimage creeps along the user's face, for example up and down the nose as the user moves his head. This is hardly noticeable by the user as the movement of the mouse indicator still corresponds closely to the movement of the head.

In one embodiment of these implementations, the invention comprises the choice of a variety of facial or other body parts as the feature to be tracked. Additionally, other features within the video image, which may be associated with the computer user, may be tracked, such as an eyeglass frame or headgear feature. Considerations that suggest the choice of one or another such feature will be apparent to one of ordinary skill in the art, and include the comfort and control abilities of a user. The results achieved with various features are discussed in greater detail in M. Betke, J. Gips, and P. Fleming, The Camera Mouse: Visual Tracking of Body Features to Provide Computer Access For People with Severe Disabilities, IEEE Transactions on Rehabilitation Engineering, submitted June, 2001.

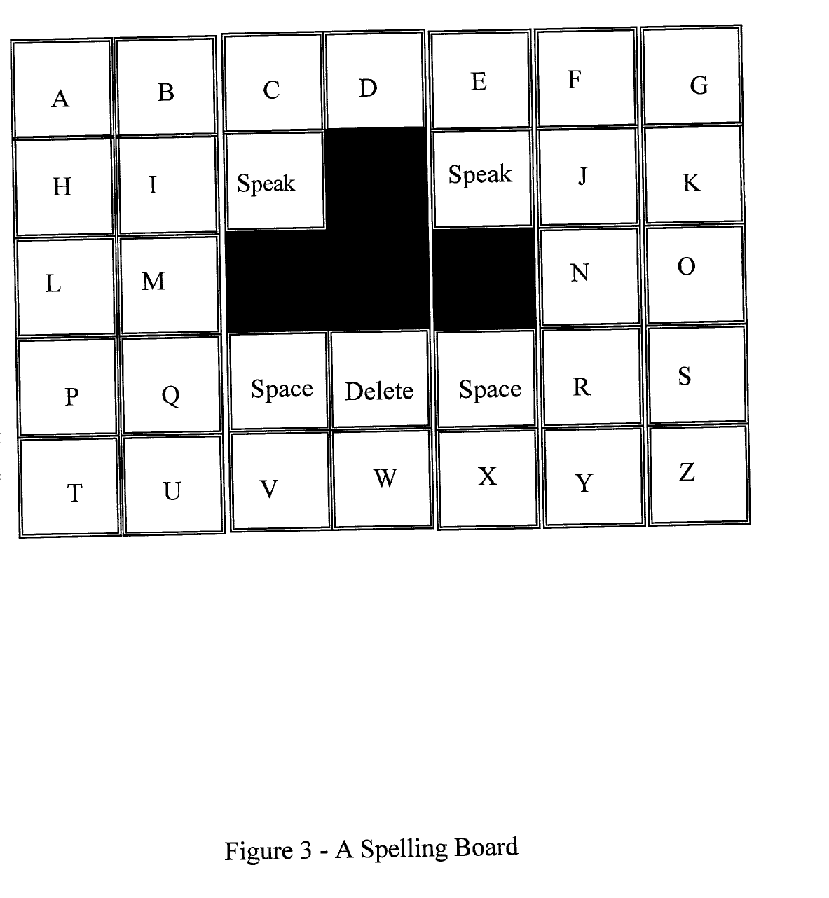

The system of the invention may be used to permit the entry of text by use of an image of a keyboard on-screen. Using 0.7 seconds dwell time, spelling may proceed at approximately 2 seconds per character, approximately 1.3 seconds to move the indicator to the square with the character and approximately 0.7 seconds to dwell there to select it, although of course these times depend upon the abilities of the particular user. FIG. 3 illustrates an on-screen Spelling Board which may be used in one embodiment to input text. Other configurations also may be used.

These embodiments have been used with a number of children with severe disabilities, as set forth more fully in M. Betke, J. Gips, and P. Fleming, The Camera Mouse: Visual Tracking of Body Features to Provide Computer Access For People with Severe Disabilities, IEEE Transactions on Rehabilitation Engineering, submitted June, 2001.

The system in accordance with one embodiment of the invention also permits the implementation of spelling systems, such as but not limited to a popular spelling system based on just a “yes” movement in a computer program. Gips J and Gips J, A Computer Program Based on Rick Hoyt's Spelling Method for People with Profound Special Needs, Proceedings of the International Conference on Computers Helping People with Special Needs, Karlsruhe, Germany, July 2000. When combined with the invention, messages may be spelled out just by small head movements to the left or right using the Hoyt or other spelling methods.

The embodiments described here do not use the tracking history from earlier than the previous image. That is, the subimage or subimages in the new frame are compared only to the corresponding subimage or subimages in the previous frame and not, for example, to the original subimage. According to one embodiment of the invention, one also may compare the current subimage(s) with past selected subimage(s), for example using recursive least squares filters or Kalman filters as described in Haykin, S., Adaptive Filter Theory, 3^{rd} edition. Prentice Hall, 1995.

Although the embodiments herein described may use the absolute location of the chosen subimage to locate the indicator on the monitor or video display screen, one embodiment of the invention may also include using the chosen subimage to control the location of the indicator on the monitor screen in other ways. In an embodiment that is analogous to the manner in which a conventional “mouse” is used, the motion in the camera viewing field of the chosen user feature or subimage between the prior iteration and the current iteration may be the basis for a corresponding movement of the indicator on the computer monitor or video display screen. In another embodiment that is analogous to the manner in which a conventional “joystick” is used, the indicator location on the monitor or video display screen may be unchanged so long as the chosen user feature remains within a defined central area of the camera image field; the indicator location on the monitor or video display screen may be moved up, down, left or right, in response to the chosen user feature or subimage being to the top, bottom, left or right of the defined central area of the camera image field, respectively. In some applications, the location of the indicator on the monitor or video display screen may remain fixed, while the background image on the monitor or video display screen may be moved in response to the location of the chosen user feature.

In another system embodiment, a video acquisition board having its own memory and processors sufficient to perform the tracking function may be used. In this embodiment, the board may be programmed to perform the functions carved out by the vision computer in the two-computer embodiment, and the board may be incorporated into the user's computer so that the system is on a single computer, but is not using the central processing unit of that computer for the tracking function.

In embodiments of the system to be employed with video games, the two-computer approach may be followed, with a vision computer providing input into the video game controller or, as in the one-computer embodiment, the functions may be carried out internally in the video game system.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A method for providing input to a system which uses a visual display for providing user information, comprising:
(a) choosing a feature associated with a system user;
(b) determining a location of the feature in a video image from a video camera at an initial time;
(c) determining a subsequent location of the feature in a video image from the video camera at a subsequent given time; and
(d) providing input to the system at the subsequent given time based upon the location of the feature in the video image at the subsequent given time.

2. The method of claim 1, wherein in the step of choosing, the feature associated with a systems user includes one of a body, face, or article of clothing.

3. The method of claim 1 wherein in the step of choosing the feature includes a portion of a substance or device affixed to the system user.

4. The method of claim 1, wherein the step of providing input includes providing vertical and horizontal coordinates.

5. The method of claim 4, wherein the vertical and horizontal coordinates are used as a basis for locating an indicator on the video display being used by the system to display material for the user.

6. The method of claim 5, wherein locating an indicator includes determining the indicator location at the given time based upon a location of the indicator at a previous time, and a change between a location of the feature in the video image at the previous time and the location of the feature in the video image at the given time.

7. The method of claim 5, wherein the indicator location is determined at the given time based upon the location of the feature in the video image at the given time independent of previous indicator locations.

8. The method of claim 4, wherein the vertical and horizontal coordinates are used as a basis for determining a direction of movement of an indicator on a video display being used by the system to display material for the user.

9. The method of claim 4, wherein the vertical and horizontal coordinates are used as a basis for determining a direction of movement of a background image on a video display screen being used by the system to display material for the user, as an indicator on the video display screen remains in a fixed position.

10. The method of claim 1, wherein the system is a computer program.

11. The method of claim 1, wherein the input is provided in response to the location of the feature in the video image changing by less than a defined amount during a defined period of time.

12. The method of claim 11, wherein:
(a) the input provided is selected from a group consisting of letters, numbers, spaces, punctuation marks, other defined characters and signals associated with defined actions to be taken by the system; and
(b) the selection of the input is determined by the location of the feature in the video image.

13. The method of claim 1, wherein the input provided is based upon a change in the location of the feature in the video image between a previous time and the given time.

14. The method of claim 1, wherein the input provided at the given time is an affirmative signal or a negative signal based on whether the motion of the feature in the video image is in a vertical direction or a horizontal direction prior to the given time.

15. The method of claim 10, wherein:
(a) the computer program is running on a first computer; and
(b) the locations of the feature in the video images are determined by a second computer.

16. The method of claim 10, wherein:
(a) the computer program is running on a computer; and
(b) the locations of the feature in the video images are determined by the computer.

17. The method of claim 10, wherein:
(a) the computer program is running on a computer; and
(b) the locations of the feature in the video images are determined by a video acquisition board on the computer.

18. The method of claim 10, wherein the computer program is a Web browser.

19. The method of claim 1, wherein determining the location of the feature in the video image at the given time further comprises:
(a) choosing a fixed area of a video image from a prior time, the fixed area containing the chosen feature at a known point therein;
(b) comparing video input signals for specified trial areas of the video image at the given time with video input signals for the fixed area of the video image from the prior time;
(c) choosing the trial area most similar to the fixed area based on the compared video input signals; and
(d) selecting as the location of the feature in the video image at the given time, a point within the chosen trial area bearing the same relationship to the chosen trial area as the known point does to the fixed area.

20. The method of claim 19, wherein the known point and the point within the chosen trial area are located at the center of the fixed area and the chosen trial area, respectively.

21. The method of claim 19 wherein choosing the trial area comprises calculating normalized correlation coefficients between the video input signals for the fixed area and for each specified trial area.

22. The method of claim 21 wherein the video input signals are greyscale intensity signals.

23. A method of providing input to a system which uses a visual display for providing user information, comprising:
(a) capturing a first video image of at least a part of a system user;
(b) choosing a feature in the first video image associated with the user;
(c) choosing a base pixel corresponding to a location of the chosen feature in the first video image;
(d) capturing a successive video image of at least the part of the user;
(e) choosing a successive pixel corresponding to the location of the chosen feature in the successive video image; and
(f) controlling the input to the system based on the location of the base pixel and the successive pixel.

24. The method of claim 23 wherein the feature is a portion of the system user's body, face, or article of clothing.

25. The method of claim 23 wherein the feature is a portion of a substance or device affixed to the system user's body, face, or article of clothing.

26. The method of claim 23, further comprising iteratively repeating steps (d), (e) and (f) with the successive pixel of one iteration used as the base pixel for the next iteration.

27. The method of claim 23, wherein choosing the successive pixel further comprises:
(a) creating a base template of pixels associated with the base pixel;
(b) selecting a window of trial pixels surrounding the base pixel;
(c) iteratively creating a trial template associated with each trial pixel, the trial template bearing the same relationship to the trial pixel as the base template does to the base pixel; and
(d) choosing as the successive pixel the trial pixel whose trial template most closely corresponds to the base template.

28. The method of claim 27, wherein choosing the successive pixel further comprises:
(a) determining a base greyscale intensity of the base template;
(b) determining a trial greyscale intensity of each trial template; and
(c) comparing each trial greyscale intensity with the base greyscale intensity.

29. The method of claim 28, wherein comparing the greyscale intensities further comprises calculating correlation coefficients for the base template with each trial template.

30. The method of claim 23, wherein:
(a) the feature comprises a plurality of sub-features;
(b) the base pixel is determined from a plurality of sub-base pixels, each sub-base pixel corresponding to a location of one of the sub-features;
(c) the successive pixel is determined from a plurality of sub-successive pixels, each sub-successive pixel corresponding to a location of one of the sub-features in the successive video image; and
(d) the successive pixel is determined from the sub-successive pixels by a same calculation as the base pixel is determined from the sub-base pixels.

31. The method of claim 30, wherein the base and successive pixels are a weighted average of the locations of the sub-base and sub-successive pixels, respectively.

32. The method of claim 23, wherein controlling the system input further comprises providing data signals to an input device of the system.

33. The method of claim 23, wherein the system is a computer program.

34. The method of claim 23, wherein controlling the input to the system comprises providing vertical and horizontal coordinates.

35. The method of claim 34, wherein the vertical and horizontal coordinates are used as a basis for locating an indicator on a video display being used by the system to display material for the user.

36. The method of claim 35, wherein the indicator location is determined at a given time based upon a location of the indicator at a previous time, and a difference between the locations of the base pixel and the successive pixel at the given time.

37. The method of claim 35, wherein the indicator location is determined at a given time based upon the location of the successive pixel at the given time independent of a previous indicator location.

38. The method of claim 34, wherein the vertical and horizontal coordinates are used as a basis for determining a direction of movement of an indicator on a video display being used by the system to display material for the user.

39. The method of claim 34, wherein the vertical and horizontal coordinates are used as a basis for determining a direction of movement of a background image on a video display screen being used by the system to display material for the user, as an indicator on the video display screen remains in a fixed position.

40. The method of claim 23, wherein the input is controlled in response to the locations of the base and successive pixels differing by less than a defined amount over a defined period of time.

41. The method of claim 40, wherein controlling the input further comprises selecting the input to the system from a group consisting of letters, numbers, spaces, punctuation marks, other defined characters and signals associated with defined actions to be taken by the system, the selection of the input being determined by the location of the successive pixel.

42. The method of claim 23, wherein the input to the system is controlled based upon the differences between the locations of the base and successive pixels.

43. The method of claim 23, wherein the input to the system is an affirmative signal or a negative signal based on whether the difference between the locations of the base and successive pixels defines a vertical or a horizontal motion.

44. A system for providing input to a computer by a user, comprising:
(a) a video camera for capturing video images of at least a part of the user and outputting video signals corresponding to the video images;
(b) a tracker for receiving the video output signals from the camera and outputting data signals corresponding to a feature associated with the user; and
(c) a driver for receiving the data signals and controlling an input device of the computer in response thereto.

45. The system of claim 44, wherein the tracker further comprises:
(a) a video acquisition board for digitizing the output signals from the video camera;
(b) a memory for storing the digitized output signals as image data; and
(c) at least one processor for comparing stored image data, determining a location of the feature in the video images and generating data signals based on the determined locations.

46. The system of claim 45, wherein the at least one processor further comprises computer-readable medium containing instructions for controlling a computer system to compare the stored image data and determine the location of the feature, by:
(a) choosing stored image data of a fixed area of a prior video image, the fixed area containing the feature as a known position therein;
(b) comparing stored image data of specified trial areas of a subsequent video image with the stored image data of the fixed area;
(c) choosing the trial area most similar to the fixed area based on the compared image data; and
(d) selecting as the location of the feature in the subsequent video image, a point within the chosen trial area bearing the same relationship to the chosen trial area as the known point does to the fixed area.
